(19) United States
(12) Patent Application Publication
(10) Pub. No.: US 2024/0281527 A1
(43) Pub. Date: Aug. 22, 2024

(54) EXTRACTION METHOD, EXTRACTION DEVICE, AND EXTRACTION PROGRAM

(71) Applicant: NIPPON TELEGRAPH AND TELEPHONE CORPORATION, Tokyo (JP)

(72) Inventors: Daiki CHIBA, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 18/290,025

(22) PCT Filed: May 12, 2021
(86) PCT No.: PCT/JP2021/018117

§ 371 Date: Nov. 9, 2023

(51) Int. Cl. G06F 21/55

(52) U.S. Cl. CPC G06F 21/554; G06F 2221/034

(57) ABSTRACT

A feature information extraction unit acquires a history of actions taken by an analyst with respect to investigation of an IOC included in information on cyber security. A feature information extraction unit creates IOC feature information on the basis of information obtained from the acquired history of actions.

### TECHNICAL FIELD

The present invention relates to an extraction method, an extraction device, and an extraction program.

### BACKGROUND ART

In order to ensure cyber security, companies or organizations have introduced a system for security management and threat detection. A security operation center (SOC) is an organization that operates such a system. SOC analysts monitor and analyze large numbers of logs and alerts which are output from the system and take necessary measures.

On the other hand, according to the following References 1 and 2, analysts who process large numbers of alerts occurring everyday undergo a situation called alert fatigue, which leads to a problem of analyst burnout.
Reference 1: S. C. Sundaramurthy, A. G. Bardas, J. Case, X. Ou, M. Wesch, J. McHugh, and S. R. Rajagopalan, “A human capital model for mitigating security analyst burnout,” Proc. SOUPS, 2015
Reference 2: Ponemon Institute, “Improving the Effectiveness of the Security Operations Center,” 2019

In addition, what is needed to solve the above problem is to realize better automation and reduce analysts' workloads. In fact, according to Reference 3, many SOC managers view the inadequate level of automation of SOC components as the most important issue in today's SOC organizations.
Reference 3: F. B. Kokulu, A. Soneji, T. Bao, Y. Shoshitaishvili, Z. Zhao, A. Doupe, and G.-J. Ahn, “Matched and Mismatched SOCs: A Qualitative Study on Security Operations Center Issues,” Proc. ACM CCS, 2019

On the other hand, for example, techniques have been proposed to distinguish between a truly malignant alert and an inherently non-malignant alert which is a false positive by estimating the abnormality score and malignancy score of each security-related alert from past alerts (see, for example, NPL 1 to 5).

In addition, techniques of extracting information which is most relevant to each security-related alert to support analysts' subsequent processes are known (see, for example, NPL 6 to 8).

### CITATION LIST

### Non Patent Literature

[NPL 1] W. U. Hassan, S. Guo, D. Li, Z. Chen, K. Jee, Z. Li, and A. Bates, “NoDoze: Combatting Threat Alert Fatigue with Automated Provenance Triage,” Proc. NDSS, 2019
[NPL 2] A. Oprea, Z. Li, R. Norris, and K. Bowers, “MADE: Security Analytics for Enterprise Threat Detection,” Proc. ACSAC, 2018
[NPL 3] K. A. Roundy, A. Tamersoy, M. Spertus, M. Hart, D. Kats, M. Dell′Amico, and R. Scott, “Smoke Detector: Cross-Product Intrusion Detection With Weak Indicators,” Proc. ACSAC, 2017
[NPL 4] Y. Liu, M. Zhang, D. Li, K. Jee, Z. Li, Z. Wu, J. Rhee, and P. Mittal, “Towards a Timely Causality Analysis for Enterprise Security,” Proc. NDSS, 2018
[NPL 5] P. Najafi, A. Muhle, W. Punter, F. Cheng, and C. Meinel, “MalRank: a measure of maliciousness in SIEM-based knowledge graphs,” Proc. ACSAC, 2019
[NPL 6] C. Zhong, J. Yen, P. Liu, and R. F. Erbacher, “Automate Cybersecurity Data Triage by Leveraging Human Analysts' Cognitive Process,” Proc. IEEE IDS, 2016
[NPL 7] C. Zhong, T. Lin, P. Liu, J. Yen, and K. Chen, “A cyber security data triage operation retrieval system,” Comput. Secur., vol. 76, pp. 12-31, 2018
[NPL 8] S. T. Chen, Y. Han, D. H. Chau, C. Gates, M. Hart, and K. A. Roundy, “Predicting Cyber Threats with Virtual Security Products,” Proc. ACSAC, 2017.

### SUMMARY OF INVENTION

### Technical Problem

However, there is a problem with the related art in that feature information useful in determining the priority of IOC investigation may not be obtained.

For example, the above techniques disclosed in Citation List employ feature information necessary to determine whether an IOC is abnormal or malignant. On the other hand, the fact that an IOC is abnormal or malignant is independent of whether the IOC requires further investigation performed by an analyst.

### Solution to Problem

In order to solve the above problem and achieve the object, there is provided an extraction method which is executed by an extraction device, including: an acquisition step of acquiring a history of actions taken by an analyst with respect to investigation of an indicator of compromise (IOC) included in information on cyber security; and a creation step of creating IOC feature information on the basis of information obtained from the history of actions acquired in the acquisition step.

### Advantageous Effects of Invention

According to the present invention, it is possible to obtain feature information useful in determining the priority of IOC investigation.

### BRIEF DESCRIPTION OF DRAWINGS

FIG. 1 is a diagram illustrating a security system.

FIG. 2 is a diagram illustrating an example of an alert monitor screen.

FIG. 3 is a diagram illustrating an example of an IOC checker screen.

FIG. 4 is a diagram illustrating a configuration example of a determination device according to a first embodiment.

FIG. 5 is a diagram illustrating an example of a request period.

FIG. 6 is a flowchart illustrating a flow of learning processing.

FIG. 7 is a flowchart illustrating a flow of processing of extracting feature information.

FIG. 8 is a flowchart illustrating a flow of prediction processing.

FIG. 9 is a diagram illustrating an example of a computer that executes a determination program.

### DESCRIPTION OF EMBODIMENTS

Hereinafter, an embodiment of an extraction method, an extraction device, and an extraction program according to the present application will be described in detail with reference to the accompanying drawings. Meanwhile, the present invention is not limited by an embodiment to be described below. Meanwhile, in the present embodiment, a determination device functions as an extraction device.

### Configuration of First Embodiment

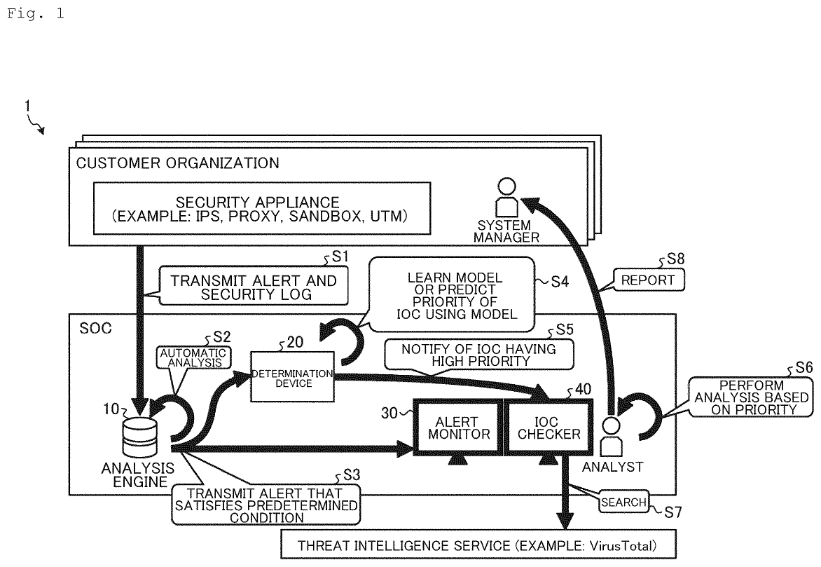

First, a security system including a determination device according to a first embodiment will be described with reference to FIG. 1. FIG. 1 is a diagram illustrating a security system.

A security system 1 performs automatic analysis using an analysis engine or analysis performed by an analyst on the basis of predetermined information generated in the security appliance of a customer organization.

Examples of the security appliance include an intrusion prevention system (IPS), a proxy, a sandbox, unified threat management (UTM), and the like.

The SOC analyzes information on security acquired from the security appliance in real time. For example, the information on security includes security logs and alerts.

In the example of FIG. 1, the SOC is used as an outsourced SOC provided by a large-scale managed security service provider (MSSP). On the other hand, the present embodiment can also be applied to an in-house SOC.

Although there is an organizational difference between the outsourced SOC and the in-house SOC, the overall workflows are similar to each other. Therefore, in the case of the in-house SOC of an organization which is large enough to take advantage of a scale merit, the effects of the present embodiment are likely to be obtained.

A flow of processing in the security system 1 will be described below. As shown in FIG. 1, the security appliance of a customer organization first transmits an alert and a security log to an analysis engine 10 of the SOC (step S1).

An example of processing an alert will be described below. The security system 1 can process a security log in same way as an alert.

The analysis engine 10 performs automatic analysis (step S2). The analysis engine 10 responds to alerts by performing analysis on the basis of known malicious characteristics, rules defined in advance, or blacklists.

The analysis engine 10 may perform analysis using a function called security orchestration, automation, and response (SOAR).

The analysis engine 10 transmits an alert that satisfies a predetermined condition to a determination device 20, an alert monitor 30, or an IOC checker 40 (step S3).

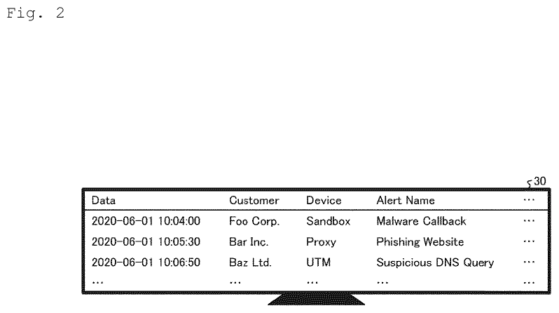

In this case, as shown in FIG. 2, the alert monitor 30 displays information on alerts. FIG. 2 is a diagram illustrating an example of an alert monitor screen.

For example, the alert monitor 30 displays the date of an event that causes the alert (Date), the name of a customer (Customer), a device that transmitted the alert (Device), the name of the alert (Alert Name), an overview of the situation that triggered the alert, and the like.

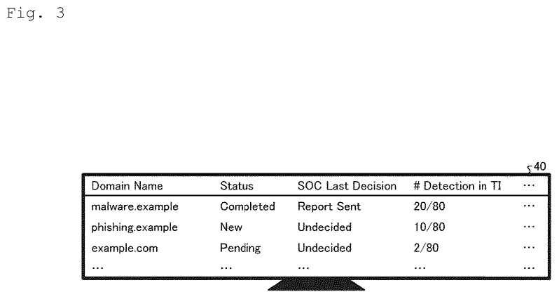

In addition, as shown in FIG. 3, the IOC checker 40 displays information on an indicator of compromise (IOC) included in the alert. FIG. 3 is a diagram illustrating of an example of an IOC checker screen.

For example, the IOC includes a domain name, an IP address, a URL, a file hash value, and the like.

As shown in FIG. 3, for example, the IOC checker 40 displays the status of investigation in the SOC (Status), the SOC's latest decision on the degree of malignancy of the IOC (SOC Last Decision), the latest threat intelligence result of the IOC (Detection in TI), and the like.

For example, analysts use dedicated tools for IOC evaluation, such as the alert monitor 30 and the IOC checker 40 to triage (evaluate) IOCs for alerts that could not be processed by the analysis engine 10.

SOC analysts process large numbers of alerts in their daily SOC workflow. Consequently, the determination device 20 determines an IOC having a high priority and notifies the analysts of it. This makes it possible to prevent a plurality of analysts from manually evaluating the same IOC in the SOC.

In addition, according to the determination device 20, an IOC having a high priority can be preferentially analyzed, and thus it is possible to improve the effect on the amount of work of the analyst.

The determination device 20 learns a model or predicts the priority of the IOC using the model (step S4). The determination device 20 determines an IOC having a high priority on the basis of the prediction result and notifies of the determined IOC (step S5).

For example, the determination device 20 notifies the analyst of the determined IOC through the IOC checker 40.

The analyst performs analysis on the basis of the notified priority (step S6). In addition, the analyst may search a threat intelligence service (for example, VirusTotal (https://www.virustotal.com/)) during the process of analysis (step S7).

Some threat intelligence services provide scores on the level of a threat or the degree of malignancy. However, originally, such scores do not necessarily determine the analyst's next action.

For example, an IOC associated with an attack that exploits vulnerability for which patches have already been developed may score high as malignant, but is not an imminent threat in terms of protecting customer organizations.

In this way, since alert analysis in the SOC is not simple, it is difficult to fully automate the alert analysis, and thus it may become necessary for the analyst to make a decision.

Therefore, it can be said that the determination of an IOC having a high priority made by the determination device 20 is useful in securing time for the analyst's decision and reducing the investigation work of each IOC.

The analyst finally determines whether the alert to be analyzed and the IOC included in the alert are malignant or non-malignant, further determines whether a report to the customer is necessary, and reports to the system manager or the like of the customer organization in a case where a report to the customer is necessary (step S8).

For example, when the analyst completes the evaluation of an IOC, conditions under which the alert is triggered in the analysis engine 10 can be changed on the basis of the result.

For example, in a case where a malignant IOC is clearly identified by the analyst's evaluation, the IOC can be used in the analysis engine 10 as a custom blacklist or a custom signature.

In that case, logs including the same IOC can be automatically detected even by other customers of the SOC. In addition, in a case where an IOC with a low false positive or threat level is identified by the evaluation, a SIEM logic that triggers the alert can be changed to prevent the same false positive alert from occurring again, which leads to a reduction in the analyst's work.

Hereinafter, a process for the determination device 20 to determine an IOC having a high priority will be described in detail together with the configuration of the determination device 20.

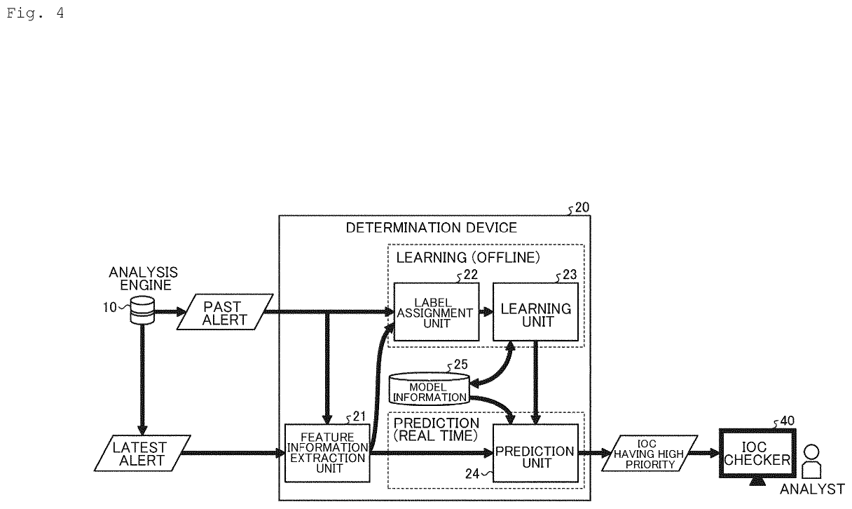

FIG. 4 is a diagram illustrating a configuration example of the determination device according to the first embodiment. As shown in FIG. 4, the determination device 20 includes a feature information extraction unit 21, a label assignment unit 22, a learning unit 23, a prediction unit 24, and model information 25.

The determination device 20 performs model learning processing using a machine learning method and prediction processing using a trained model.

In the learning processing, the feature information extraction unit 21, the label assignment unit 22, and the learning unit 23 are used. In addition, in the prediction processing, the feature information extraction unit 21 and the prediction unit 24 are used.

The feature information extraction unit 21 extracts feature information from the IOC included in information on cyber security. For example, the information on cyber security is an alert acquired from the analysis engine 10.

The feature information extraction unit 21 extracts information (hereinafter referred to as feature information) that characterizes the characteristics of an IOC from the IOC included in the past alert obtained from the analysis engine 10.

The feature information may be a domain name, an IP address, a URL, a file hash value, and the like included in the IOC.

For example, the feature information extraction unit 21 extracts feature information from an alert generated during a predetermined fixed number of days.

Here, a method of extracting feature information which is performed by the feature information extraction unit 21 will be described in detail. The feature information extraction unit 21 functions as an extraction device having an acquisition unit and a creation unit.

The acquisition unit acquires a history of actions taken by an analyst about investigation of an IOC included in the information on cyber security. The creation unit creates feature information of the IOC on the basis of information obtained from the history of actions acquired by the acquisition unit.

The feature information extraction unit 21 creates feature information on the basis of the history of actions indicating when and how much an analyst of which shift investigated each IOC as the whole SOC.

For example, the feature information extraction unit 21 observes a request executed by the analyst to investigate each IOC, and creates feature information from information on the observation.

As shown in step S7 of FIG. 1, the analyst may send a request for search to the threat intelligence service for the IOC included in the alert from the customer organization in the SOC workflow.

Consequently, the feature information extraction unit 21 can obtain information on a request to the threat intelligence service as an action history of the analyst.

The feature information extraction unit 21 does not need to individually acquire the action history of each analyst in detail. In addition, the feature information extraction unit 21 can acquire the action history without changing the daily SOC workflow. In addition, in most of the SOC, the action history as described above can be easily obtained.

In the present embodiment, the feature information extraction unit 21 is assumed to extract a total of 80 pieces of feature information consisting of three large items and eight small items.

The feature information extraction unit 21 extracts feature information using five different time windows (for example, one day, three days, seven days, fourteen days, and thirty days).

By using a plurality of different time windows in this way, the feature information extraction unit 21 can identify an IOC included in the alert observed in a burst manner in a short period of time and an IOC of the alert observed in a longer period of time.

In addition, the feature information extraction unit 21 further divides the latest one week into one day, three days, and seven days, thereby obtaining feature information appropriate for the prediction of priority in real time in which more recent information is emphasized.

Feature information of each item will be described below. First, the feature information of Item 1 is feature information based on the timing of the analyst's request. The number of pieces of feature information included in Item 1 is, for example, fifty-five. Feature information of items denoted as Item X-Y below is assumed to be feature information included in Item X.

The feature information extraction unit 21 creates feature information included in Item 1 on the basis of information on the number of actions and the interval of time between the actions. For example, the number of actions and the interval of time between the actions are the number of requests to the threat intelligence service and the interval between requests.

### (Item 1-1)

The feature information extraction unit 21 counts the number of request queries to the threat intelligence service used by the SOC for each of five time windows (for example, one day, three days, seven days, fourteen days, and thirty days) as feature information. Thereby, the feature information extraction unit 21 obtains, for example, five pieces of feature information.

The reason for using the feature information of Item 1-1 is that each suspected candidate IOC manually investigated by the SOC analyst has a different feature.

For example, there is an IOC included in an alert which is observed simultaneously by many customer organizations in a short period of time, or conversely, there is an IOC which is observed by a plurality of customer organizations in a long period of time.

### (Item 1-2)

The feature information extraction unit 21 calculates statistics such as the average, minimum, maximum, standard deviation, and variance of the number of requests in Item 1-1 as feature information. Thereby, the feature information extraction unit 21 obtains, for example, twenty-five pieces of feature information.

In this way, the feature information extraction unit 21 creates feature information on the basis of information obtained from the history of actions and statistics calculated from the information.

According to the feature information in Item 1-2, it is possible to ascertain the tendency of how a plurality of analysts at the SOC base have investigated the IOC within each time window.

### (Item 1-3)

The feature information extraction unit 21 calculates statistics such as the average, minimum, maximum, standard deviation, and variance of the interval of time between requests as feature information. Thereby, the feature information extraction unit 21 obtains, for example, twenty-five pieces of feature information.

The feature information of Item 1-3 contributes to distinguishing between an IOC investigation request used in a targeted attack against a specific customer company and an IOC investigation request used in a non-targeted attack performed indiscriminately against a plurality of companies.

For example, the IOC used in a targeted attack reaches only some companies and their employees, and as a result, is relatively rare for the SOC analyst to investigate. On the other hand, since the IOC used in a non-targeted attack is widely distributed regardless of companies and their employees, a plurality of analysts at the same SOC base will investigate it in a short period of time.

The feature information of Item 2 is feature information based on the period of the analyst's request. The number of pieces of feature information included in Item 2 is, for example, fifteen.

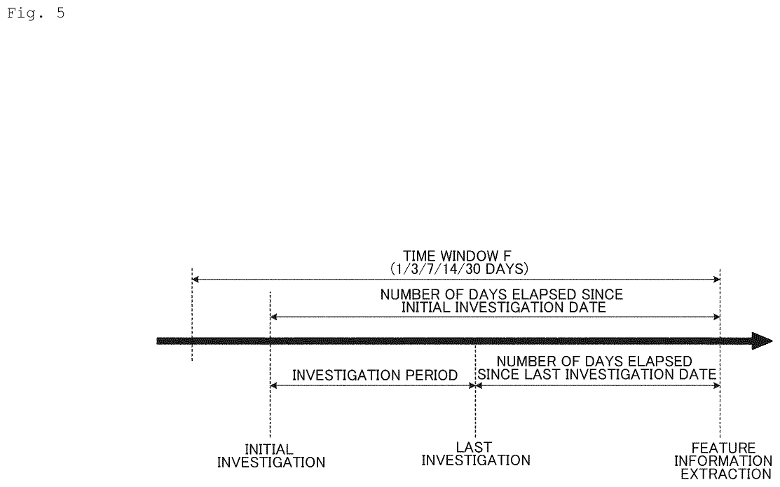

The feature information extraction unit 21 creates feature information included in Item 2 on the basis of information on the elapsed time from a point in time when an action was performed within a predetermined time window. Each period used in Item 2 is as shown in FIG. 5. FIG. 5 is a diagram illustrating an example of a request period.

### (Item 2-1)

The feature information extraction unit 21 calculates the number of days elapsed since the initial investigation date for each time window as feature information. Thereby, the feature information extraction unit 21 obtains, for example, five pieces of feature information.

According to the feature information of Item 2-1, it is possible to distinguish between an IOC that has been investigated by the analyst from early on and an IOC that has been investigated recently.

### (Item 2-2)

The feature information extraction unit 21 calculates the number of days elapsed since the last investigation date for each time window as feature information. Thereby, the feature information extraction unit 21 obtains, for example, five pieces of feature information.

According to the feature information of Item 2-2, it is possible to distinguish whether the IOC has been continuously investigated by the analyst until recently.

### (Item 2-3)

The feature information extraction unit 21 calculates the number of days elapsed from the initial investigation date to the last investigation date by the analyst for each time window as feature information. Thereby, the feature information extraction unit 21 obtains, for example, five pieces of feature information.

According to the feature information of Item 2-3, it is possible to distinguish between an IOC that has been investigated by the analyst for a long period of time and an IOC that has been investigated only for a short period of time.

The feature information of Item 3 is feature information based on the analyst's shift. The number of pieces of feature information included in Item 3 is, for example, ten.

The feature information extraction unit 21 creates the feature information of Item 3 on the basis of the date and time when the action was performed and information on the analyst's work pattern.

### (Item 3-1)

The feature information extraction unit 21 calculates the percentage of weekdays when the analyst made a request to the threat intelligence service for each time window as feature information. For example, the weekday is assumed to be Monday through Friday in the local time at a place where the base of the SOC is located. Thereby, the feature information extraction unit 21 obtains, for example, five pieces of feature information.

The SOC analyst often investigates IOCs included in alerts observed recently from the customer organization during the weekday. On the other hand, the analyst tends to investigate unusual IOCs on weekends or actively investigate threats which cannot be done on weekdays due to the lower absolute number of alerts. The feature information of Item 3-1 is feature information considering such a tendency.

### (Item 3-2)

The feature information extraction unit 21 calculates the percentage of times when the analyst made a request to the threat intelligence service during the day shift, for each time window, as feature information. For example, the analyst's shift may include a day shift (for example, 8:00 to 16:00) and a night shift (for example, 16:00 to 8:00 the next day) in order to cope with 24 hours and 365 days. Thereby, the feature information extraction unit 21 obtains, for example, five pieces of feature information.

Similarly to the relationship between weekdays and weekends described above, the tendency of the analyst's investigation may differ between the day shift and the night shift. The feature information of Item 3-2 is feature information considering such a tendency.

The label assignment unit 22 assigns, to each IOC, a label corresponding to the actual amount of work required to respond to an associated alert.

Here, the label is assumed to binary data indicating whether the priority is high. For example, the label assignment unit 22 assigns a label indicating that the priority is high to an IOC that has consumed a large amount of work of the analyst in the past, and assigns a label indicating that the priority is not high to other IOCs.

Meanwhile, in the related art (for example, techniques disclosed in NPL 4 to 8), a label indicating whether the IOC is malignant (or malicious) is assigned. On the other hand, in the present embodiment, a label is assigned on the basis of the amount of work of the analyst.

The label assignment unit 22 assigns a label indicating that the priority is high to an IOC for which the number of manual investigations having occurred within a certain period for an associated alert is equal to or greater than a predetermined value among the IOCs, and assigns a label indicating that the priority is not high to an IOC for which the number of manual investigations is less than a predetermined value.

In the following description, a label indicating that the priority is high is referred to as “priority,” and a label indicating the priority is not high is referred to as “non-priority.”

The learning unit 23 uses learning data obtained by combining the feature information extracted by the feature information extraction unit 21 and the label assigned by the label assignment unit 22 to learn a model that outputs a label from IOC feature information.

The learning unit 23 creates and updates a model through supervised machine learning. The model information 25 is information including parameters and the like for constructing a model. The learning unit 23 creates and updates the model information 25.

The learning unit 23 can adopt any known supervised machine learning algorithm. In the present embodiment, the learning unit 23 is assumed to adopt standard logistic regression.

Logistic regression is scalable and fast, and thus it is suitable for predicting an IOC included in large numbers of alerts from many customers as in the SOC environment.

In addition, logistic regression is known to be highly interpretable. The output of logistic regression, by its nature, can be interpreted as the probability that the input IOC is given priority, and can also indicate which feature of the feature information corresponding to each IOC contributes to the result. In this way, logistic regression has the advantage of high interpretation possibility.

Here, the learning unit 23 is assumed to particularly use logistic regression with L1 regularization.

First, when a vector x indicating the feature information extracted by the feature information extraction unit 21 is given, the learning unit 23 models the conditional probability y of the label shown in Equation (1) as in Equation (2).

$$[ Math 1 ]$$

$$y ∈ \{ 0 ( non - priority ) , 1 ( priority ) \} \qquad ( 1 )$$

$$[ Math 2 ]$$

$$p ( y = 1 \vert x ; θ ) = σ ( {θ}^{T} x ) = 1 / ( 1 + exp ( - {θ}^{T} x ) ) \qquad ( 2 )$$

Here, θ is a parameter of the logistic regression model. In addition, σ is a sigmoid function. In addition, all features of x are assumed to be normalized to the range of [0, 1].

The learning unit 23 uses a set of learning data with n labels shown in Equation (3) in order to obtain the parameter θ in minimizing the objective function of Equation (4) into which the hyper parameter A for determining the degree of regularization is introduced.

$$[ Math 3 ]$$

$${\{ ( {x}_{i} , {y}_{i} ) \}}_{i = 1}^{n} \qquad ( 3 )$$

$$[ Math 4 ]$$

$${min}_{θ} {\sum }_{i = 1}^{n} - log p ( {y}_{i} \vert {x}_{i} ; θ ) + λ {‖ θ ‖}_{1} \qquad ( 4 )$$

In Equation (4), the L1 regularization part λ∥θƒ₁ adds a penalty to the objective function, and has the effect of identifying and reducing feature information that does not contribute significantly.

Such reduction of feature amount not only contributes to preventing overfitting to match learning data more than necessary, but also has the effect of reducing memory usage and making it easier to interpret results presented to the SOC analyst more concisely.

The prediction unit 24 uses the model trained by the learning unit 23 to predict a label from the IOC feature information.

The prediction unit 24 uses the model trained by the learning unit 23 to input IOCs included in alerts newly generated in real time and corresponding feature information and predict which IOC will consume a large amount of work of the analyst in the future.

For example, the prediction unit 24 makes a prediction using a logistic regression model constructed on the basis of the model information 25.

For example, the prediction unit 24 predicts the probability that the analyst manually analyzes a target IOC K times or more within P days (where P is an integer).

The prediction unit 24 uses the parameter θ determined by the learning unit 23 to obtain the probability p that the vector x of feature information corresponding to the IOC is “priority” and to define a label \hat{ }y to be predicted (\hat{ }directly above y) as Equation (5).

$$[ Math 5 ]$$

$$\hat{y} = \{ \begin{matrix}1 , & if p ( y \vert x ; θ ) \geq 0.5 \\ 0 , & otherwise\end{matrix} \qquad ( 5 )$$

The determination device 20 outputs IOCs considered to lead to repeated investigation performed by the SOC analyst, that is, IOCs for which the “priority” label is predicted, in descending order of probability p on the basis of the label predicted by the prediction unit 24, and presents them to the analyst.

In this case, the analyst can use the information presented by the determination device 20 to prioritize investigation targets and efficiently perform triage and detailed analysis.

The SOC analyst is required to determine and record what actions should be taken against the IOC insofar as possible.

According to the present embodiment, the analyst can investigate an IOC having a high priority and reflect the result in the analysis engine 10. This makes it possible for the analysis engine 10 to automatically process alerts including the same IOC, and thus it is possible to avoid the need for the analyst to manually investigate the IOC each time, and to achieve the reduction of the amount of work for the entire SOC.

For example, the analyst investigates an IOC determined to have a high priority and causes the analysis engine 10 to automatically analyze the IOC on the basis of the result. Thereby, since the IOC is not delivered to other analysts, the amount of work is reduced.

Meanwhile, the determination device 20 re-executes the learning processing offline periodically (for example, once a day) and updates the model information 25. The determination device 20 performs the learning processing using data for a predetermined period before and after a point in time of feature information extraction shown in FIG. 5. For example, the determination device 20 performs the learning processing using data for F+L days which is the sum of F days up to a point in time of feature extraction (equivalent to a time window) and L days from a point in time of feature information extraction (where F and L are integers).

On the other hand, when the determination device 20 processes an IOC included in an alert from the customer organization in real time, that is, when the prediction processing is performed, the feature information is extracted using data for the past F days with respect to the IOC.

The determination device 20 then calculates the probability p that the analyst performs K or more manual investigations in the future P days from the extracted feature information.

The determination device 20 repeats the above prediction processing for each IOC received in real time. As a result, a list of IOCs to be preferentially investigated by the analyst is displayed on the screen of the IOC checker 40 as shown in FIG. 3 and is continuously updated.

### [Processing According to First Embodiment]

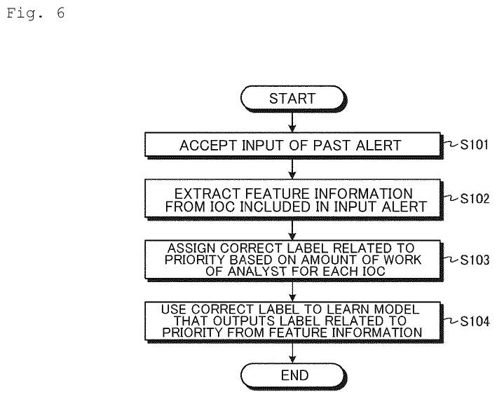

FIG. 6 is a flowchart illustrating a flow of learning processing. As shown in FIG. 6, the determination device 20 first accepts input of the past alerts (step S101).

Next, the determination device 20 extracts feature information from the IOC included in the input alert (step S102). Subsequently, the determination device 20 assigns a correct label related to priority on the basis of the amount of work of the analyst for each IOC (step S103).

The determination device 20 then uses the correct label to learn a model that outputs a label related to priority from the feature information (step S104).

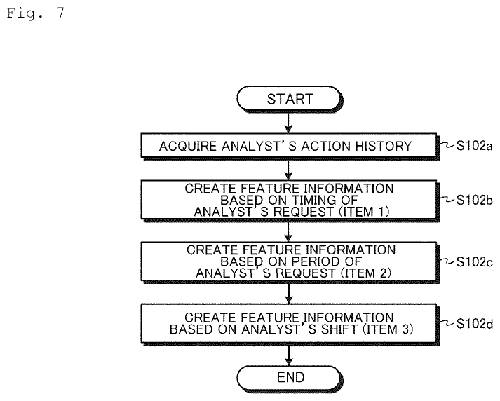

FIG. 7 is a flowchart illustrating a flow of processing of extracting feature information. The processing of FIG. 7 is equivalent to step S102 in FIG. 6.

First, as shown in FIG. 7, the determination device 20 acquires the analyst's action history (step S102a).

Next, the determination device 20 creates feature information based on the timing of the analyst's request (Item 1) (step S102b). Subsequently, the determination device 20 creates feature information based on the period of the analyst's request (Item 2) (step S102c). Further, the determination device 20 creates feature information based on the analyst's shift (Item 3) (step S102d).

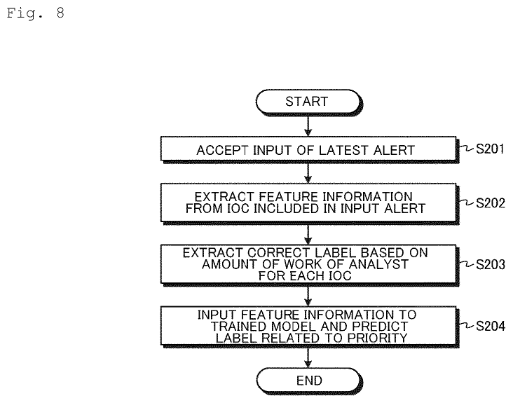

FIG. 8 is a flowchart illustrating a flow of prediction processing. As shown in FIG. 8, the determination device 20 first accepts input of the latest alert (step S201).

Next, the determination device 20 extracts feature information from the IOC included in the input alert (step S202). Subsequently, the determination device 20 extracts a correct label on the basis of the amount of work of the analyst for each IOC (step S203).

The determination device 20 then inputs the feature information to the trained model and predicts a label related to priority (step S204).

The determination device 20 can notify the SOC analyst of an IOC having a high priority on the basis of the predicted label.

### Effects of First Embodiment

As described so far, the feature information extraction unit 21 acquires the history of actions taken by the analyst with respect to the investigation of IOCs included in the information on cyber security. The feature information extraction unit 21 creates IOC feature information on the basis of information obtained from the acquired history of actions.

Thereby, it is possible to obtain feature information useful for determining the priority of the IOC investigation.

The feature information extraction unit 21 creates feature information on the basis of information on the number of actions and the interval of time between the actions.

Thereby, the feature information extraction unit 21 can reflect the tendency of the analyst's IOC investigation in the feature information.

The feature information extraction unit 21 creates feature information on the basis of information on the elapsed time from a point in time when the action was performed within a predetermined time window.

Thereby, the feature information extraction unit 21 can reflect, in the feature information, whether the IOC has been investigated for a long period of time or investigated only for a short period of time.

The feature information extraction unit 21 creates feature information on the basis of the date and time when the action was performed and information on the analyst's work pattern.

Thereby, the feature information extraction unit 21 can reflect the tendency of investigation content according to the analyst's work shift in the feature information.

The feature information extraction unit 21 creates feature information on the basis of information obtained from the history of actions and statistics calculated from the information.

Thereby, the feature information extraction unit 21 can obtain more feature information from limited information.

### [System Configuration and the Like]

In addition, components of the devices illustrated in the drawings are functionally conceptual and are not necessarily physically configured as illustrated in the drawings. That is, the specific aspects of distribution and integration of the devices are not limited to those illustrated in the drawings. All or some of the components may be distributed or integrated functionally or physically in desired units depending on various kinds of loads and states of use, or the like. Further, all or desired some of the processing functions performed by the devices can be realized by a CPU (Central Processing Unit) and a program analyzed and executed by the CPU, or be realized as hardware based on a wired logic. Meanwhile, the program may be executed not only by the CPU but also other processors such as a GPU.

In addition, all or some of the processes described as automatically performed processes out of the processes described in the present embodiment may be performed manually. Alternatively, all or some of the processes described as manually performed processes may be performed automatically by a known method. Furthermore, the processing procedures, the control procedures, the specific names, and the information including various types of data and parameters described in the present specification and the drawings can be optionally changed unless otherwise mentioned.

### [Program]

As an embodiment, the determination device 20 can be implemented by installing a determination program for executing the above determination processing as package software or online software on a desired computer. For example, an information processing device can be allowed to function as the determination device 20 by causing the information processing device to execute the above determination program. The information processing device referred to here includes a desktop-type or a notebook-type personal computer. In addition thereto, the category of the information processing device includes a mobile communication terminal such as a smartphone, a cellular phone, or a personal handyphone system (PHS), a slate terminal such as a personal digital assistant (PDA), and the like.

In addition, the determination device 20 can also be implemented as a determination server device that uses a terminal device used by a user as a client to provide the client with a service related to the above determination processing. For example, the determination server device is implemented as a server device that provides a determination service with an alert related to security as an input and an IOC having a high priority as an output. In this case, the determination server device may be implemented as a web server, or may be implemented as a cloud that provides a service related to the above determination processing through outsourcing.

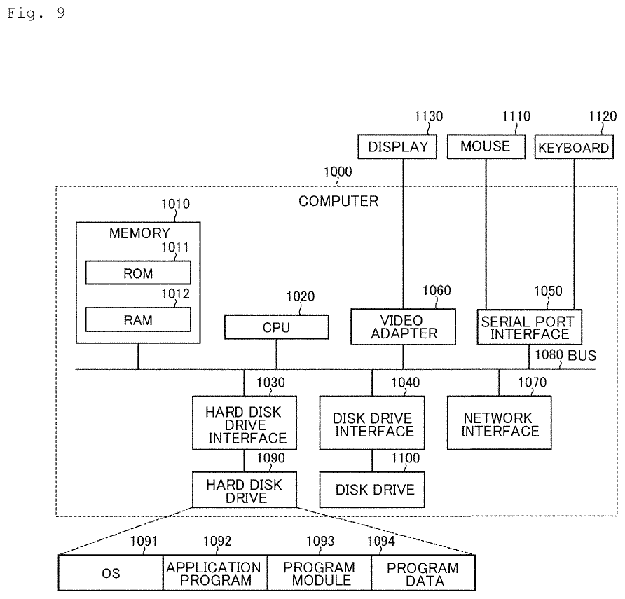

FIG. 9 is a diagram illustrating an example of a computer that executes a determination program. A computer 1000 includes, for example, a memory 1010 and a CPU 1020. In addition, the computer 1000 includes a hard disk drive interface 1030, a disk drive interface 1040, a serial port interface 1050, a video adapter 1060, and a network interface 1070. These units are connected to each other through a bus 1080.

The memory 1010 includes a read only memory (ROM) 1011 and a random access memory (RAM) 1012. The ROM 1011 stores a boot program such as, for example, a basic input output system (BIOS). The hard disk drive interface 1030 is connected to a hard disk drive 1090. The disk drive interface 1040 is connected to a disk drive 1100. A removable storage medium such as, for example, a magnetic disc or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program for specifying each process of the determination device 20 is implemented as the program module 1093 in which a computer-executable code is written. The program module 1093 is stored on, for example, the hard disk drive 1090. For example, the program module 1093 for executing processing similar to the functional configuration in the determination device 20 is stored in the hard disk drive 1090. Meanwhile, the hard disk drive 1090 may be replaced with a solid state drive (SSD).

In addition, the setting data used for the processing of the above-described embodiment is stored in, for example, the memory 1010 or the hard disk drive 1090 as the program data 1094. The CPU 1020 reads out the program module 1093 or the program data 1094 stored in the memory 1010 or the hard disk drive 1090, as necessary, into the RAM 1012, and executes the processing of the above-described embodiment.

Meanwhile, the program module 1093 and the program data 1094 are not necessarily stored in the hard disk drive 1090, and may be stored in, for example, a removable storage medium and be read out by the CPU 1020 through the disk drive 1100 or the like. Alternatively, the program module 1093 and the program data 1094 may be stored in another computer connected through a network (such as a local area network (LAN) or a wide area network (WAN)). The program module 1093 and the program data 1094 may be read out by the CPU 1020 from another computer through the network interface 1070.

### REFERENCE SIGNS LIST

1 Security system
10 Analysis engine
20 Determination device
21 Feature information extraction unit
22 Label assignment unit
23 Learning unit
24 Prediction unit
25 Model information
30 Alert monitor
40 IOC checker

1. An extraction method which is executed by an extraction device, comprising:
acquiring a history of actions taken by an analyst with respect to investigation of an indicator of compromise (IOC) included in information on cyber security; and
creating IOC feature information on the basis of information obtained from the history of actions acquired by the acquiring.

2. The extraction method according to claim 1, wherein the creating creates the feature information on the basis of information on the number of actions and an interval of time between the actions.

3. The extraction method according to claim 1, wherein the creating creates the feature information on the basis of information on an elapsed time from a point in time when the action was performed within a predetermined time window.

4. The extraction method according to claim 1, wherein the creating creates the feature information on the basis of information on a date and time when the action was performed and the analyst's work pattern.

5. The extraction method according to claim 1, wherein the creating creates the feature information on the basis of information obtained from the history of actions and a statistic calculated from the information.

6. An extraction device comprising: a memory; and a processor coupled to the memory and programmed to execute a process comprising:
acquiring a history of actions taken by an analyst with respect to investigation of an indicator of compromise (IOC) included in information on cyber security; and
creating IOC feature information on the basis of information obtained from the history of actions acquired by the acquiring.

7. A non-transitory computer-readable recording medium storing therein a processing program that causes a computer to execute a process comprising:
acquiring a history of actions taken by an analyst with respect to investigation of an indicator of compromise (IOC) included in information on cyber security; and
creating IOC feature information on the basis of information obtained from the history of actions acquired by the acquiring.
